(19) United States
(12) Patent Application Publication
(10) Pub. No.: US 2012/0124297 A1
(43) Pub. Date: May 17, 2012

(54) COHERENCE DOMAIN SUPPORT FOR MULTI-TENANT ENVIRONMENT

(76) Inventors: Jaewoong Chung, Bellevue, WA (US); Steven K. Reinhardt, Vancouver, WA (US); David E. Mayhew, Northborough, MA (US); Mark D. Hummel, Franklin, MA (US)

(21) Appl. No.: 12/945,226

(22) Filed: Nov. 12, 2010

(51) Int. Cl. G06F 12/08; G06F 12/00

(52) U.S. Cl. 711/141; 711/E12.001; 711/E12.026

(57) ABSTRACT

A method includes bypassing a global coherence operation that maintains global memory coherence between a plurality of local memories associated with a plurality of corresponding processors. The bypassing is in response to an address of a memory request being associated with a local memory coherence domain. The method includes accessing a memory location associated with the local memory coherence domain according to the memory request in response to the address being associated with the local memory coherence domain.

### BACKGROUND

1. Field of the Invention

The invention is related to computing systems and more particularly to multi-memory request handling in computing systems.

2. Description of the Related Art

In a typical shared-memory, multi-processor system, a processor (i.e., central processing unit, digital signal processor, graphics processor, processor core, or core) may attempt to process a particular memory location simultaneously with at least one other processor. If neither processor modifies the contents of the memory location, the processors can share that memory location indefinitely. However, as soon as one processor modifies the value of the memory location, the other processor will be operating on an out-of-date copy of the contents of the memory location. A mechanism for notifying all processors of the multi-processor system of changes to shared memory locations is referred to as a “memory coherence mechanism.” For example, in a multi-processor system, each processor includes cache memory that may contain local entries corresponding to entries of a common memory resource. A cache coherence mechanism manages conflicts to maintain consistency between contents of a cache of a processor and corresponding contents of memory.

Exemplary cache coherence mechanisms include directory-based coherence, snooping, and snarfing mechanisms. A typical directory-based coherence mechanism places shared data in a common directory that maintains coherence between caches. A processor must ask permission from the directory to load an entry from primary memory into a cache memory. When a processor changes an entry, the directory either updates other caches containing that entry or invalidates at least a corresponding cache entry. In general, snooping is a technique in which individual caches monitor address lines for accesses to memory locations that they have cached. When a cache observes a write operation to a location for which the cache includes a copy, a corresponding cache controller invalidates its own copy of the snooped memory location. A typical snooping mechanism requires that every memory request be broadcast to all processors sharing the same memory of the multi-processor system. In yet another cache coherence mechanism, i.e., snarfing, a cache controller of a first processor of a multi-processor system monitors both address and data lines in an attempt to update a copy of data in a cache of a processor when another processor modifies a corresponding location in memory. When the cache controller observes a write operation by another processor to a memory location for which the cache includes a copy, the cache controller updates the copy of the memory location with the new data.

As the number of processors increases (e.g., in cloud computing applications), the amount of additional coherence message traffic and/or additional metadata storage increases, thereby increasing the cost and complexity of implementing a coherence mechanism. Accordingly, improved techniques for implementing a memory coherence mechanism are desired.

### SUMMARY OF EMBODIMENTS OF THE INVENTION

In at least one embodiment of the invention, a method includes bypassing a global coherence operation that maintains global memory coherence between a plurality of local memories associated with a plurality of corresponding processors. The method includes accessing a memory location associated with the local memory coherence domain according to the memory request. The bypassing and accessing are in response to an address of a memory request being associated with a local memory coherence domain.

In at least one embodiment of the invention, an apparatus includes a first processor and a coherence system associated with the first processor. The coherence system is operable to perform an operation to maintain memory coherence between a first memory local to the first processor and at least a second memory local to a second processor in response to a memory request associated with an address in a global memory domain. The coherence system is operable to bypass the operation in response to the address being associated with a local memory domain.

In at least one embodiment of the invention, an apparatus includes system management software embodied in a computer readable storage medium. The system management software is executable on at least a first processor to write an indicator of an address range associated with a local memory coherence domain in at least one storage element to thereby partition local memory into memory associated with at least one local coherence domain and memory associated with a global coherence domain.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of a shared memory, multi-processor system consistent with at least one embodiment of the invention.

FIG. 2 illustrates a functional block diagram of an exemplary processing node consistent with at least one embodiment of the invention.

FIG. 3 illustrates a functional block diagram of exemplary coherence management hardware consistent with at least one embodiment of the invention.

FIG. 4 illustrates a functional block diagram of an exemplary processing node including multiple cores consistent with at least one embodiment of the invention.

FIG. 5 illustrates a functional block diagram of an exemplary processing node including a substantial number of cores consistent with at least one embodiment of the invention.

The use of the same reference symbols in different drawings indicates similar or identical items.

### DETAILED DESCRIPTION

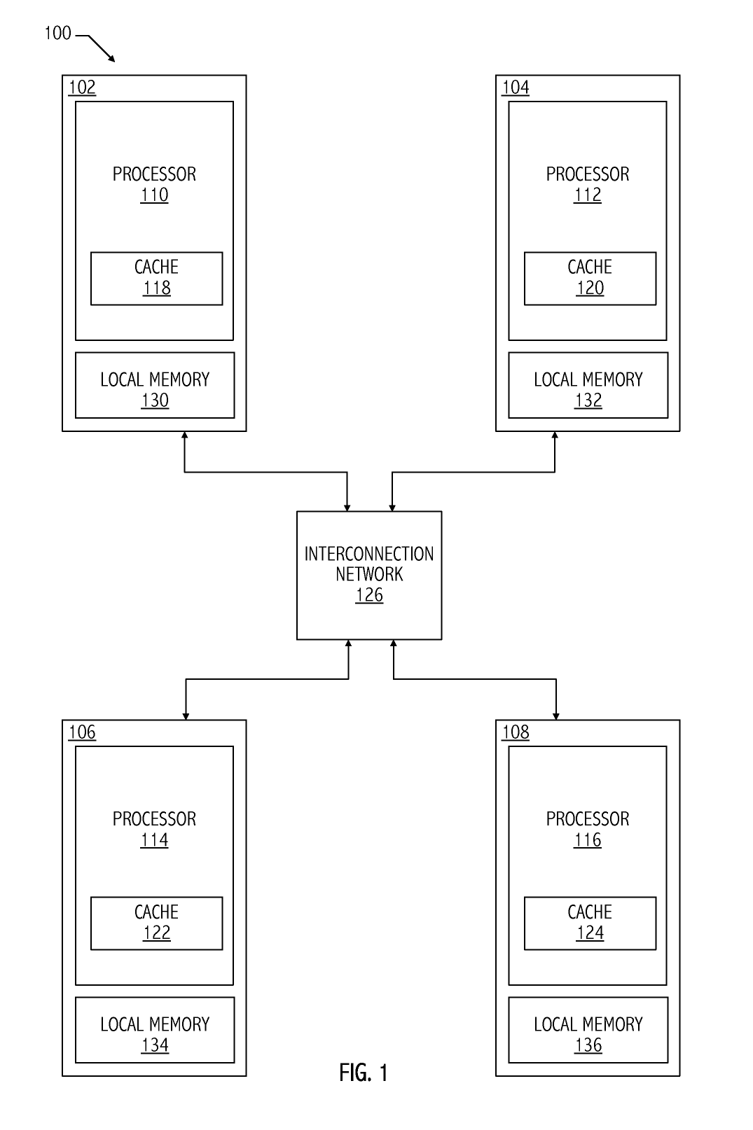

Referring to FIG. 1, system 100 is an exemplary non-uniform memory access system (e.g., system 100). System 100 includes multiple processing nodes (e.g., processing nodes 102, 104, 106, and 108) coupled by a network (e.g., interconnection network 126). Embodiments of interconnection network 126 include a HyperTransport link, Intel QuickPath Interconnect, and/or other suitable networks. Each processing node includes local memory (e.g., local memories 130, 132, 134, and 136) and one or more processors (e.g., processors 110, 112, 114, and 116), each of which typically includes cache memory (e.g., caches 118, 120, 122, and 124). In general, memory access time of a memory request depends on the location of a target memory location relative to a processor that requested the memory request. A particular processing node of processing nodes 102, 104, 106, and 108 can access its own local memory faster than non-local, or remote, memory, i.e., memory local to another processing node of processing nodes 102, 104, 106, and 108 or a separate memory unit shared between the processors.

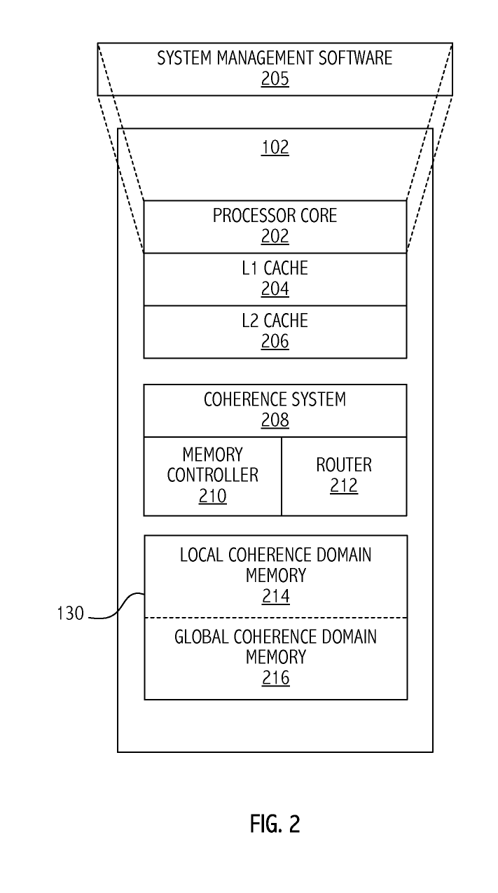

Referring to FIG. 2, an exemplary processing node (e.g., processing node 102) includes a processor (e.g., processing core 110), local memory (e.g., local memory 130), and a memory controller (e.g., memory controller 210) that manages the local memory. The physical address space of local memory 130 is partitioned to form at least two memory portions, i.e., a memory portion having an address space associated with a global coherence domain (e.g., global coherence domain memory 216) and a memory portion having an address space associated with at least one local coherence domain (e.g., local coherence domain memory 214). Only one global coherence domain exists in system 100 (e.g., global coherence domain memory 216). In at least one embodiment of system 100, global coherence domain memory 216 is coherent over system 100 in its entirety and is managed using one or more baseline coherence mechanisms (e.g., included in coherence system 208). In at least one embodiment, coherence system 208 implements a baseline coherence mechanism that includes any suitable coherence mechanism (e.g., directory-based coherence, snooping and/or snarfing).

In at least one embodiment of system 100, processing node 102 includes only one local coherence domain, although other embodiments of processing node 102 include multiple local coherence domains. Memory associated with a local coherence domain is used only locally, e.g., is used by a processing core 202, which is physically the closest processing core and has the shortest communications paths to memory 130 of system 100. The node hardware system and system management software, e.g., system management software 205, which may include operating system software and/or hypervisor (i.e., virtual machine monitor) software, collaborate to manage the local coherence domain. The system management software manages memory accesses using policy goals of data locality and data isolation. In at least one embodiment, system management software 205 promotes data locality by allocating data of an application in a local memory of a node that executes the application. If system management software 205 reschedules an application executing on processing node 102 for execution at a later time, system management software 205 reassigns memory requests for the application again to processing node 102, which is the processing node that had previously executed the application. Since the application executes on the same processing node that includes the corresponding memory, system management software 205 reduces the memory access latency.

In at least one embodiment, system management software 205 fosters data isolation by independently running applications from different clients that share the processing node on different resources. For example, system 100 executes independent applications in an isolated/virtualized environment (e.g., using a separate processor and/or a separate virtual machine) and only the individual applications access corresponding data. In some embodiments of exemplary system 100, application data is predominately located in local memory and not shared over system 100. In such embodiments, it is unnecessary for system 100 to exchange coherence messages for application data across multiple nodes.

In at least one embodiment of processing node 102, system management software 205 interacts with coherence system 208 to reduce coherence maintenance overhead. In at least one embodiment, coherence system 208 is implemented in hardware as part of an on-chip network. In at least one embodiment, system management software 205 establishes a local coherence domain per processing node (e.g., using memory associated with local coherence domain memory 214). That is, system management software 205 allocates a physical address range of memory residing on processing node 102 or multiple disjoint address ranges of memory residing on processing node 102 for each processing node. The address range associated with a particular local coherence domain does not span over multiple local memories of multiple processing nodes. However, there is no restriction on virtual-to-physical mapping for physical pages from local coherence domains.

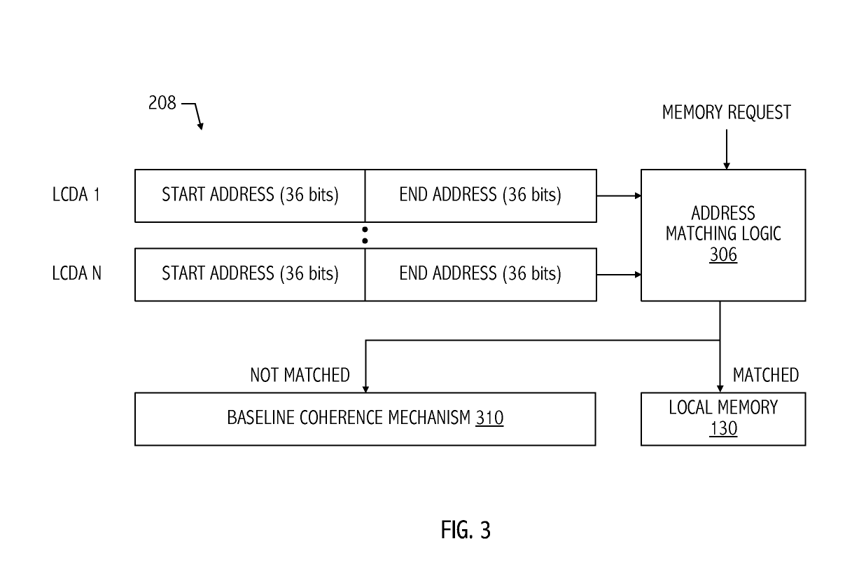

In at least one embodiment, system management software 205 sends the physical address ranges allocated to a local coherence domain to coherence system 208 in the corresponding node. For example, referring to FIG. 3, coherence system 208 stores those physical address ranges in a set of local coherence domain address (LCDA) registers (e.g., LCDA 1, . . . , LCDAN). In at least one embodiment of coherence system 208, each LCDA register includes two fields indicating the beginning and the end of a physical address range associated with a particular local coherence domain. In at least one embodiment of coherence system 208, the address ranges are aligned to 4K page size and use only 36 bits per field for a 48-bit physical address space. The physical address ranges not covered by the LCDA registers are associated with the global coherence domain. The number of LCDA registers is limited and a particular coherence system trades off the hardware cost of the LCDA registers with software flexibility for managing local coherence domains.

Referring back to FIG. 2, in at least one embodiment, system management software 205 instructs coherence system 208 as to which physical address ranges are associated with application data corresponding to an application executing on the processing node to thereby reduce coherence maintenance overhead for those address ranges. In at least one embodiment, system management software 205 adjusts or reduces the range of local coherence domain memory 214 to increase global coherence domain memory 216. In at least one embodiment, system management software 205 increases global coherence domain memory 216 in response to a substantial change in the applications executing on system 100. For example, system management software 205 increases global coherence domain memory 216 in response to executing a new set of applications on system 100 when those applications include many threads and/or a substantial amount of shared data. However, note that in at least one embodiment, local coherence domain memory 214 may not be increased since a physical range to be added to local coherence domain memory 214 is part of global coherence domain memory 216, which is shared by multiple nodes and copies of data corresponding to those address ranges may be present in cache memory of the other nodes. In at least one embodiment, system management software 205 flushes copies of data corresponding to address ranges of global coherence domain memory 216 out of the non-local caches before increasing the size of local coherence domain memory 214 by including those address ranges.

Referring back to FIG. 3, in at least one embodiment, coherence system 208 uses the LCDA registers to bypass baseline coherence mechanism 310. Upon arrival of a memory request, address matching logic 306 first determines whether the memory request has a target memory location in local coherence domain memory 214 by comparing the requested memory address with the address ranges stored in the LCDA registers. If the requested address is within one of the address ranges specified in the LCDA registers, the memory locations associated with the local coherence domain are guaranteed to be unshared and no coherence action is needed. Accordingly, coherence system 208 sends the memory request directly to local memory 130 and bypasses baseline coherence mechanism 310. If the requested address is not within one of the address ranges specified in the LCDA registers, coherence system 208 forwards the memory request to baseline coherence mechanism 310 for system-wide coherence maintenance using any suitable technique. For example, baseline coherence mechanism 310 broadcasts messages to processing nodes 104, 106, and 108 using interconnection network 126 of FIG. 1. In at least one embodiment of processing node 102, the LCDA registers and address matching logic 306 are included in an on-chip network, although the LCDA registers and address matching logic 306 may be located in other portions of processing node 102.

In at least one embodiment of coherence system 208, rather than include new LCDA registers in processing node 102, coherence system 208 uses existing hardware for defining the local coherence domain of memory 214. For example, in at least one embodiment, coherence system 208 uses existing memory type range registers (MTRRs) of a processor (e.g., processing core 202) having an x86 architecture for that purpose. In at least one embodiment of processing core 202, the MTRRs are a set of control registers that provide system management software 205 with control over how accesses to memory ranges by a processor are cached. The MTRRs indicate one of multiple x86 architecture memory types (e.g., uncached, write-through, write-combining, write-protect, and write-back) and an additional type (e.g., local-exclusive), to specify one or more local coherence domains. A memory request is tagged with an indicator (e.g., a Local Exclusive (LE) indicator, which may be a single bit) based on the contents of the MTRR. In at least one embodiment, the LE bit indicates that the request is to a local coherence domain memory. Then, before resorting to baseline coherence mechanism 310, coherence system 208 simply checks whether the LE bit is set. If the bit is set (i.e., indicates that the request is to a local coherence domain memory), then the memory request bypasses baseline coherence mechanism 310 and coherence system 208 communicates the memory request directly to local memory 130.

In at least one embodiment of coherence system 208, rather than include new LCDA registers in processing node 102, coherence system 208 uses an existing x86 architecture page attribute table (PAT) of a processor (e.g., processing core 202) having an x86 architecture. The PAT allows software to specify memory types per memory page. Rather than include new LCDA registers, the hybrid memory coherence mechanism extends an existing PAT to include an additional type (e.g., local-exclusive) to specify one or more local coherence domains. A memory request is tagged with an indicator (e.g., a Local Exclusive (LE) indicator, which may be a bit) based on the contents of the PAT. In at least one embodiment, the LE bit indicates that the request is to a local coherence domain memory. Then, before resorting to baseline coherence mechanism 310, coherence system 208 checks whether the LE bit is set. If the bit is set (i.e., indicates that the request is to a local coherence domain), then the memory request bypasses baseline coherence mechanism 310, and coherence system 208 communicates the memory request directly to local memory 130.

By collaborating with system management software 205 that configures local coherence domain memory 214 with a few physical address ranges, coherence system 208 can use just a few registers to record data sharing information over large address ranges. As a result, embodiments of coherence system 208 substantially reduce storage requirements for recording metadata for coherence maintenance in comparison to recording the same information at the granularity of cache lines or cache regions.

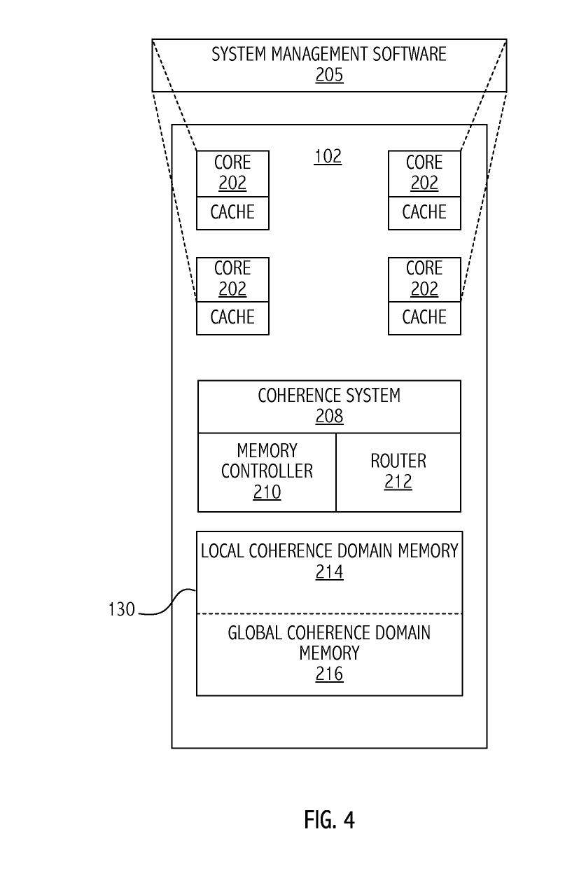

Referring back to FIG. 1, in at least one embodiment of system 100, one or more of processing nodes 102, 104, 106, and 108 include multiple processing cores, each processing core having a private cache. Those cores require coherence maintenance actions for a memory request having a target memory address in a local coherence domain of the node. Referring to FIG. 4, in at least one embodiment, processing node 102 includes a number of processing cores per node (e.g., two to four processing cores per node). For example, each of processing cores 202 includes a corresponding cache memory. In at least one embodiment of processing node 102, processing cores 202 are directly connected to other processing cores 202 through an extension executing on top of additional natively implemented interconnect interfaces (e.g., HyperTransport) allowing support of a cache-coherent Non-Uniform Memory Access (ccNUMA) multi-processor memory access protocol and symmetric multiprocessing techniques. In at least one embodiment of system 100, to maintain cache coherence among the multiple caches associated with the local coherence domain, coherence system 208 broadcasts coherence messages to individual processing cores of processing node 102 without requiring additional storage to record information on data sharing among those cores. In general, the coherence messages indicate to a processing core that stale copies of contents of a memory location need to be deleted from the corresponding cache and an updated copy needs to be obtained from local coherence domain memory 214. Coherence system 208 operates as described above to bypass baseline coherence among other nodes when a target of a memory request is in local coherence domain memory 214.

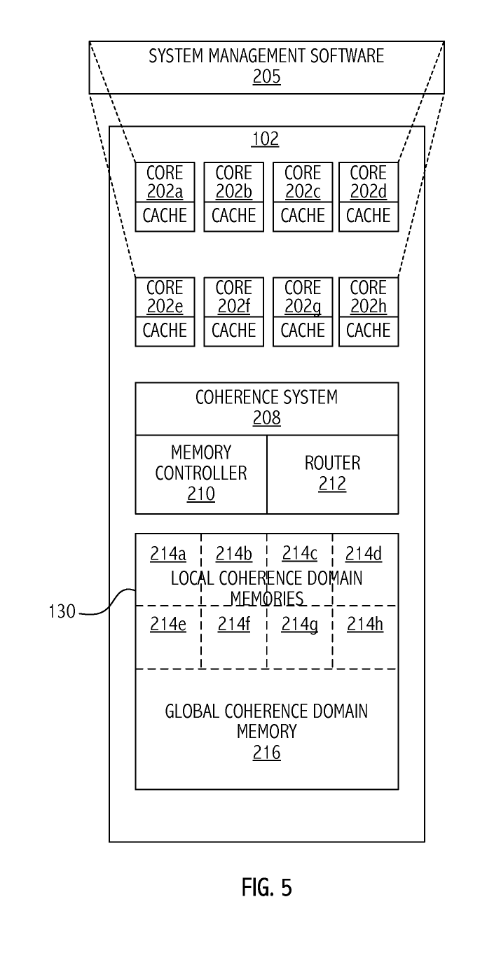

Referring to FIG. 5, in at least one embodiment, processing node 102 includes a substantial number of processing cores per processing node (e.g., greater than eight processing cores per processing node). Each of those processing cores includes a corresponding cache memory, and processing node 102 establishes a local coherence domain corresponding to each core (e.g., using local coherence domain memory portions 214a-h, which correspond to respective processing cores of processing cores 202a-202h). As a result, a processing node includes multiple local coherence domains, each local coherence domain being accessible by a single processing core. In at least one embodiment of processing node 102, a memory request from a processing core 202 to a corresponding local coherence domain does not trigger coherence actions since the memory request is private to the particular processing core 202. In at least one embodiment of processing node 102, to support processing core local coherence domains for a plurality of processing cores on a processing node, the LCDA registers are extended to include a processing core identifier and additional LCDA registers to manage the multiple local coherence domains in node 102.

In at least one embodiment of processing node 102, cache coherence may be performed using any suitable cache coherence mechanism that maintains consistency between all caches in a system of distributed shared memory according to a particular consistency model (e.g., cache coherence mechanisms known in the art that implement MSI protocol, MESI protocol, MOSI protocol, MOESI protocol, MERSI protocol, MESIF protocol, Write-once protocol, Synapse protocol, Berkeley protocol, Firefly protocol, or Dragon protocol).

Structures described herein may be implemented using software executing on a processor (which includes firmware) or by a combination of software and hardware. Software, as described herein, may be encoded in at least one tangible computer-readable storage medium. As referred to herein, a tangible computer-readable storage medium includes at least a disk, tape, or other magnetic, optical, or electronic storage medium.

While circuits and physical structures have been generally presumed in describing embodiments of the invention, it is well recognized that in modern semiconductor design and fabrication, physical structures and circuits may be embodied in computer-readable descriptive form suitable for use in subsequent design, simulation, test or fabrication stages. Structures and functionality presented as discrete components in the exemplary configurations may be implemented as a combined structure or component. Various embodiments of the invention are contemplated to include circuits, systems of circuits, related methods, and tangible computer-readable medium having encodings thereon (e.g., HDL, Verilog, GDSII data) of such circuits, systems, and methods, all as described herein, and as defined in the appended claims. In addition the computer-readable storage media may store instructions as well as data that can be used to implement the invention. The instructions/data may be related to hardware, software, firmware or combinations thereof.

The description of the invention set forth herein is illustrative, and is not intended to limit the scope of the invention as set forth in the following claims. For example, while the invention has been described in embodiments in which processing cores have an x86 architecture and existing structures of those architectures (e.g., PAT and MTRRs) are utilized and/or modified, one of skill in the art will appreciate that the teachings herein can be utilized with other processor architectures and available structures of those other processor architectures. Variations and modifications of the embodiments disclosed herein, may be made based on the description set forth herein, without departing from the scope and spirit of the invention as set forth in the following claims.

What is claimed is:

1. A method comprising:
in response to an address of a memory request being associated with a local memory coherence domain:
bypassing a global coherence operation that maintains global memory coherence between a plurality of local memories associated with a plurality of corresponding processors; and
accessing a memory location associated with the local memory coherence domain according to the memory request.

2. The method, as recited in claim 1, further comprising:
applying the global coherence operation to the memory request and accessing a global memory coherence domain according to the memory request, otherwise.

3. The method, as recited in claim 1, further comprising:
in response to the address being associated with the global memory coherence domain:
applying at least one global coherence operation to the memory request; and
accessing a memory location associated with the global memory coherence domain according to the memory request.

4. The method, as recited in claim 1, further comprising:
allocating memory associated with one of a global memory coherence domain and the local memory coherence domain to an application executing on the processor according to data access patterns associated with the application.

5. The method, as recited in claim 1, further comprising:
partitioning a physical address space of a first local memory of the plurality of local memories into an address space associated with the local memory coherence domain and an address space associated with a global memory coherence domain.

6. The method, as recited in claim 1, wherein the local memory coherence domain is local to a processing node of a plurality of processing nodes in a system.

7. The method, as recited in claim 1, wherein the local memory coherence domain is local to a processing core of a plurality of processing cores on a processing node of a system.

8. An apparatus comprising:
a first processor; and
a coherence system associated with the first processor, the coherence system being operable to perform an operation to maintain memory coherence between a first memory local to the first processor and at least a second memory local to a second processor in response to a memory request associated with an address in a global memory domain, and operable to bypass the operation in response to the address being associated with a local memory domain.

9. The apparatus, as recited in claim 8, wherein the first processor and the coherence system are included in a first non-uniform memory access node of a plurality of non-uniform memory access nodes.

10. The apparatus, as recited in claim 8, wherein the coherence system comprises:
address matching logic; and
a storage element operable to contain an indicator of a local domain address range,
wherein the address matching logic is operable to compare the indicator to an indicator of a memory address associated with a memory request.

11. The apparatus, as recited in claim 10, wherein the storage element is a local domain address register.

12. The apparatus, as recited in claim 10 wherein the storage element includes a processing node identifier and a processing core identifier.

13. The apparatus, as recited in claim 10, wherein the storage element is a page attribute table.

14. The apparatus, as recited in claim 10, wherein the storage element is a memory type range register.

15. The apparatus, as recited in claim 8, wherein the local coherence domain is local to a processing node.

16. The apparatus, as recited in claim 8, wherein the local memory coherence domain is local to a processing core of a plurality of processing cores on a processing node of a system.

17. An apparatus comprising:
system management software embodied in a computer readable storage medium and executable on at least a first processor to write an indicator of an address range associated with a local memory coherence domain in at least one storage element to thereby partition local memory into memory associated with at least one local coherence domain and memory associated with a global coherence domain.

18. The apparatus, as recited in claim 17, wherein the system management software includes at least one of operating system software and virtual machine monitor software.

19. The apparatus, as recited in claim 17, wherein the system management software is executable to allocate memory for an application executing on a processing node in a memory associated with the processing node.

20. The apparatus, as recited in claim 17, wherein the at least one storage element includes at least one of a local domain address register, a page attribute table, and a memory type range register.

21. The apparatus, as recited in claim 17, wherein the system management software is executable to write at least one of a processing node identifier and a processing core identifier associated with the local memory coherence domain to the storage element.
